(19) United States
(12) Patent Application Publication
(10) Pub. No.: US 2015/0291401 A1
(43) Pub. Date: Oct. 15, 2015

(54) Lattice boom for a crane, lattice element for a lattice boom of this type, and crane comprising a lattice boom of this type

(71) Applicant: Terex Cranes Germany GmbH, Zweibrucken (DE)

(72) Inventors: Peter ORFEY, Homburg (DE); Rüdiger ZOLLONDZ, Hornbach (DE); Marco BUSCONI, Rottofreno (IT)

(21) Appl. No.: 14/251,745

(22) Filed: Apr. 14, 2014

(51) Int. Cl. B66C 23/70

(52) U.S. Cl. CPC B66C 23/70

(57) ABSTRACT

A lattice boom for a crane comprises a number of lattice elements which are in each case arranged one behind the other in such a way that their respective lattice element longitudinal axes are oriented along a lattice boom longitudinal axis, wherein each lattice element has a lattice element width which is oriented perpendicular to the lattice element longitudinal axis and is greater than 4 m when in a work arrangement, and wherein each lattice element, when in the work arrangement, falls below permissible maximum dimensions for a transport of the lattice element.

### CROSS-REFERENCES TO RELATED APPLICATIONS

This application claims the priority of Utility Model Application No. DE 20 2013 003 432.7 filed on 12 Apr. 2013, pursuant to 35 U.S.C. 119(a)(d), the content of which is incorporated herein by reference as if fully set forth herein.

### FIELD OF THE INVENTION

The invention relates to a lattice boom for a crane, a lattice element for a lattice boom of this type, and a crane comprising a lattice boom of this type.

### BACKGROUND OF THE INVENTION

A lattice boom crane is known from US 2009/015 9547 A1. In order to allow for ever increasing bearing loads, a lattice boom cross-sectional surface can be increased in a direction perpendicular to a lattice boom longitudinal axis. An oversize cross-section of a lattice boom having a width of for instance more than 4 m causes problems during the transport of the lattice boom.

Various approaches are known from prior art describing a dividable, collapsible and/or foldable structure of individual lattice elements allowing a transport volume of the lattice element to be reduced. For instance, EP 0 609 998 A1 discloses a lattice boom crane divided along its length in such a way that the lattice boom is separable in a symmetry plane in such a way as to reduce the height of the lattice boom for transporting the latter. Converting the lattice elements from a work arrangement having a maximum lattice element volume into a transport arrangement having a reduced lattice element volume is complicated. A mobile large crane comprising a dismountable lattice element is also known from DE 10 2006 060 347 A1, from U.S. Pat. No. 3,564,789 and from NL 1 035 078 C, for example.

### SUMMARY OF THE INVENTION

An object of the present invention is to provide a lattice boom having a number of lattice elements, which lattice boom has a high load bearing capacity on the one hand and is easily transportable on the other.

This object is achieved according to the invention by a lattice boom for a crane comprising a number of lattice elements arranged one behind the other in such a way that their respective lattice element longitudinal axes are oriented along a lattice boom longitudinal axis, wherein each lattice element has a lattice element width which is oriented perpendicular to the lattice element longitudinal axis and is greater than 4 m when in a work arrangement, and in the work arrangement, each lattice element falls below permissible maximum dimensions for a transport of the lattice element.

A lattice boom has a number of lattice elements which are in particular detachably interconnectable. The lattice elements are in each case arranged one behind the other in such a way that a respective lattice element longitudinal axis thereof is arranged along a lattice boom longitudinal axis. The lattice element longitudinal axes are oriented parallel to each other and in particular parallel to the lattice boom longitudinal axis. Each lattice element has a lattice element width oriented perpendicular to the lattice element longitudinal axis which, in a work arrangement, is greater than 4 m. Work arrangement means that the lattice elements are interconnectable to form a lattice boom. In the work arrangement, each of the lattice elements has a cross-sectional surface oriented perpendicular to the lattice element longitudinal axis which ensures an increased load bearing capacity for each individual lattice element and therefore for a lattice boom made up of said lattice elements. In the work arrangement, the lattice element width in particular amounts to more than 6 m and in particular to up to 8 m or more. Lattice elements of this type allow for an uncomplicated design of a lattice boom having an increased load bearing capacity by virtue of the fact that the lattice elements are arranged and interconnected one behind the other along the lattice boom longitudinal axis. At the same time, the lattice elements are configured in such a way that they are transportable in the work arrangement. This means that in the work arrangement, each lattice element has a lattice element volume such that permissible transport dimensions for a transport are not exceeded. According to the invention, it was also found that a lattice boom having an increased load bearing capacity may also be formed by lattice elements which are transportable in the work arrangement, in particular on the road, on rails and/or in transport containers provided for this purpose. Consequently, an essential feature is that the lattice boom is assembled from a plurality of short lattice sections oriented along the lattice element longitudinal axis, wherein each of the lattice sections has an increased lattice element width to ensure the required load bearing capacity. The lattice sections according to the invention are wide and short. The lattice elements according to the invention differ from the prior art approach pursued so far according to which the available transport volume is fully used by designing the lattice elements in such a way as to have a maximum length. The available transport volume is fully used by designing the lattice elements in such a way as to have a maximum width. The other dimensions of the lattice elements are defined such as to comply with the maximum permissible transport volume. The lattice element is transportable in the work arrangement. This means that the lattice element is in particular identical in the work arrangement and in the transport arrangement. It is in particular not required for the lattice element to be dismounted, folded and/or collapsed in order to achieve the maximum permissible transport dimensions. This is achieved in that the other lattice element dimensions apart from the lattice element width, in particular a lattice element length oriented along the lattice element longitudinal axis and a lattice element height which is in each case oriented perpendicular to the lattice element width and to the lattice element length, are selected in such a way that permissible transport dimensions are not exceeded. The lattice element length and the lattice element height are in particular smaller than the lattice element width. The lattice element length and/or the lattice element height are in particular smaller than 4 m. In particular, the lattice element width is the greatest dimension of the substantially cubic lattice element. Permissible transport dimensions of this type are determined by the selected route of transport. For instance, maximum permissible transport heights must not be exceeded to ensure that a road transport, in particular under bridges, is possible. In order to prevent such a road transport from being declared an oversize transport, a permissible transport width must be complied with. If this transport width is exceeded, additional safety precautions must be taken, for instance in the form of escort vehicles. On German motorways, oversize transports are preferably only permitted at night. In these cases, transport is complicated and expensive. Similarly, permissible transport dimensions are determined correspondingly for water freight, for rail transport or air freight. The applicable transport dimensions may vary depending on the transport infrastructure. It is in particular conceivable for permissible transport dimensions to change in the course of time as a result of a change in legislation. Permissible transport dimensions may also be different in different countries and/or territories. What is essential is that the lattice element can be easily transported without requiring additional steps such as dismounting, folding and/or collapsing. In particular the lattice element length is reduced compared to prior art lattice elements. The lattice boom has a design which is simple and rugged at the same time. Mounting and dismounting the lattice boom assembled from the above-described lattice elements can be performed quickly, thus requiring less time.

According to an advantageous embodiment, each lattice element of a lattice boom has a lattice element length oriented parallel to the lattice element longitudinal axis which is smaller than 4 m and in particular amounts to no more than 3.5 m in the work arrangement. The lattice element has an increased cross-sectional surface oriented perpendicular to the lattice element longitudinal axis. At the same time, the lattice element length L is reduced. A lattice boom of this type has lattice elements which are wide and short at the same time.

According to another advantageous embodiment, the lattice elements are in each case in the shape of a cuboid and are in particular hollow along the lattice element longitudinal axis. A lattice element of this type is substantially configured in the shape of a rectangular hollow profile. A lattice element of this type and a lattice boom made thereof have a high intrinsic stability obtained using less material. The specific weight of a lattice boom of this type is reduced. Since all lattice elements may be hollow, the resulting lattice boom is hollow as well.

According to another advantageous embodiment, the lattice element is configured in one piece and has a lattice element frame. The lattice element frame is in particular inseparable and rigid. The lattice element has an improved rigidity and stability. The lattice element frame may for instance have a rod structure, wherein a plurality of rods and/or tubes are welded together to form the lattice element frame. A rod structure of this type may be composed of chord tubes and diagonal rods arranged therebetween.

Alternatively, it is also conceivable to provide four chord tubes which are in each case in particular oriented parallel to the lattice element longitudinal axis and are rigidly interconnected, for instance by welding. The side surfaces of a lattice element frame formed of four chord tubes may in particular be filled with rods and/or plates.

According to a particularly preferred embodiment, an upper and lower end, or front and rear end, respectively, of the lattice element, which are in each case oriented along the lattice element longitudinal axis, are in each case provided with at least one connection device. The connection device allows two lattice elements arranged next to each other along the lattice boom longitudinal axis to be interconnected. A connection device of this type may for instance be a flange welded to the lattice element frame that is provided with at least one connection opening. Connection devices of this type allow connection elements such as screws or bolts to be passed through, in particular parallel to the lattice element longitudinal axis, for interconnecting the lattice elements. It is also conceivable for a connection device to be provided with connection lugs allowing the connection elements in the form of bolts or screws to be passed through, in particular in a plane perpendicular to the lattice element longitudinal axis.

According to another advantageous embodiment, the lattice element frame is provided with at least one reinforcing element. The at least one reinforcing element is arranged in a plane oriented parallel to the lattice element longitudinal axis. This means that the at least one reinforcing element is arranged on side surfaces of the cuboid-shaped lattice element and in particular not on cover surfaces oriented perpendicular to the lattice element longitudinal axis. The reinforcing element may be in the shape of a rod or a plate. The reinforcing elements may be rigidly connected to the lattice element frame, for instance by welding. The reinforcing elements may also be arranged on the lattice element frame in a detachable manner, for instance in the form of a plug-in connection or a bolt connection. This allows the transport weight to be reduced even more by transporting the reinforcing elements separately from the lattice element frame.

According to another advantageous embodiment, the lattice element is composed of more than one component. As a result, the lattice element may be converted from the work arrangement into a transport arrangement in such a way that the required transport dimensions of the lattice element are reduced even more. This may lead to additional advantages during transport. In particular, more than one lattice element may be transported at the same transport volume.

In another advantageous embodiment, the lattice element is foldable. By folding the lattice element, a lattice element width in the folded-out work arrangement of the lattice element may be converted to a lattice element width in a folded-in transport arrangement such that the lattice element width in the transport arrangement is reduced. In particular, the lattice element width in the transport arrangement is smaller than 4 m and amounts in particular to no more than 3 m.

According to another advantageous embodiment, the lattice element comprises a number of components which are oriented along the lattice element width and are articulated to each other. The components are in particular in the shape of a rod, a frame and/or a plate. When the lattice element is folded, the components may in each case be pivoted relative to each other along a pivot axis oriented parallel to the lattice element longitudinal axis. This allows the lattice element width in the transport arrangement to be reduced.

According to another advantageous embodiment, the lattice element is composed of a number of components which are detachably interconnected. In the work arrangement, the components are rigidly interconnected. In the transport arrangement, the components are detached from each other in such a way that the lattice element width in the detached transport arrangement is smaller than the lattice element width in the connected work arrangement. The lattice element width in the transport arrangement is in particular smaller than 4 m and amounts in particular to no more than 1 m. The required transport volume for a lattice element of this type is considerably reduced.

According to another advantageous embodiment, the components are configured as side components which are frame-like. The side components are in particular configured as rectangular frames. Each of the side components is arranged in a plane spanned by the lattice element width and the lattice element longitudinal axis. The side components are parallel to each other and arranged on the lattice element at a distance from each other. The side components are detachably interconnected.

According to a particularly advantageous embodiment, the side components are interconnected in a reinforcing manner by means of at least one rod element and/or a tie fastener which may in particular be fastened to the rod elements. A tie fastener of this type may for instance be a fiber glass tie fastener. A fiber glass tie fastener has a particularly low weight and allows a high-strength fastening to be achieved.

According to another advantageous embodiment, the lattice elements are detachably interconnected along the lattice element longitudinal axis. This may in particular be done using connection elements oriented along the lattice element longitudinal axis and/or perpendicular to the lattice element longitudinal axis. Suitable connection elements are for instance bolts and/or screws.

According to another advantageous embodiment, each lattice element is provided with a number of, in particular four, corner bars. The corner bars are in particular configured as chord tubes. The respective longitudinal axes of the corner bars define corner points of a cross-sectional surface of the lattice element oriented perpendicular to the lattice element longitudinal axis. The corner bars are substantially oriented along the lattice element longitudinal axis. This ensures that the cross-sectional surface is constant along the lattice element longitudinal axis. It may be desirable to change the cross-sectional surface along the lattice element longitudinal axis, for instance to allow for a cross-section transition. A lattice element of this type is referred to as adapter lattice element. Relative to the lattice boom longitudinal axis, adapter elements of this type may be arranged at a lower and/or upper end of the lattice boom to allow the lattice elements to be connected with a foot component for pivotable articulation of the lattice boom to the crane or with a head component for rope guidance of a hook block.

Another object of the invention is to provide a lattice element which allows a lattice boom to be formed which has an increased load bearing capacity while providing for an easier transport of the lattice element.

This object is achieved according to the invention by a lattice element for a lattice boom according to the invention. In the work arrangement, a lattice element of this type has a lattice element width oriented perpendicular to the lattice element longitudinal axis which is greater than 4 m, in particular greater than 6 m, and in particular greater than 8 m. In the work arrangement, the lattice element does not exceed the permissible transport dimensions for a transport. This means that the lattice element is easily transportable in the work arrangement, in particular without having to be converted into the transport arrangement.

The advantages thereof correspond to those of the lattice boom according to the invention to which reference is made.

Another object of the present invention is to provide a crane comprising a lattice boom, wherein the lattice boom has an increased load bearing capacity and is easily transportable at the same time.

This object is achieved according to the invention by a crane comprising a lattice boom according to the invention. A crane of this type has the advantages of the lattice boom according to the invention to which reference is made.

Exemplary embodiments of the invention will be explained in more detail below with reference to the drawing.

### BRIEF DESCRIPTION OF THE DRAWING

FIG. 1 shows a schematic side view of a crawler crane comprising a lattice boom composed of a number of lattice elements;

FIG. 2 shows a greatly schematic view of the lattice boom according to arrow II in FIG. 1;

FIG. 3 shows a perspective view of a lattice element according to one embodiment of the invention;

FIG. 4 shows a side view of a section of a lattice boom comprising two interconnected lattice elements according to FIG. 3;

FIG. 5 shows a perspective view corresponding to FIG. 3 of a lattice element according to another embodiment of the invention;

FIG. 6 shows a sectional view according to section plane VI-VI in FIG. 5;

FIG. 7 shows a plan view of a lattice element in a folded-out work arrangement according to another embodiment of the invention in a plane perpendicular to the lattice element longitudinal axis;

FIG. 8 shows a view of the lattice element corresponding to FIG. 7 in a folded-in transport arrangement;

FIG. 9 shows a perspective view of a lattice element according to another embodiment of the invention;

FIG. 10 shows a view of the lattice element according to FIG. 9 in a transport arrangement in which components of the lattice elements are detached from each other; and

FIG. 11 shows a view, corresponding to FIG. 7, of a lattice element according to another embodiment of the invention comprising reinforcing elements.

### DESCRIPTION OF THE PREFERRED EMBODIMENTS

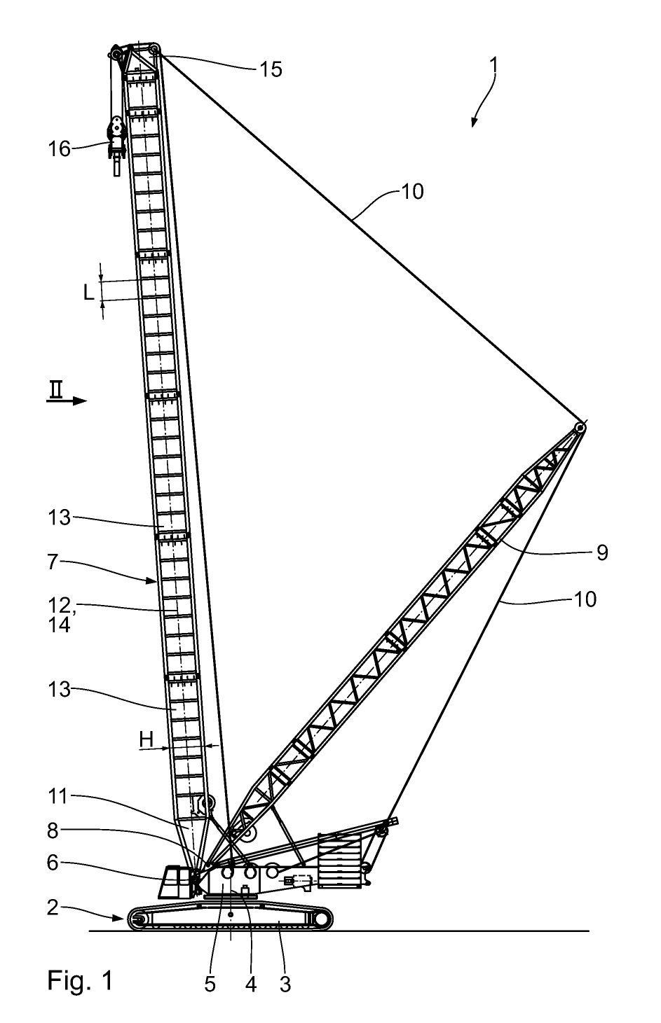

A crane 1 shown in FIG. 1 is configured as a crawler crane comprising two crawler tracks 3 arranged parallel to each other on an undercarriage 2. An upper structure 5 is arranged on the undercarriage 2 for rotation about a vertical axis of rotation 4. A lattice boom 7 is articulated to the upper structure 5 in a vertical plane, which corresponds to the drawing plane in FIG. 1, in such a way as to allow for a luffing movement about a horizontal luffing axle 6.

Additionally, a boom tensioning device 9 is articulated to the upper structure 5 in such a way as to allow for a pivoting movement about a horizontal pivot axis 8. The lattice boom 7 is tensioned by means of a guy wire 10 which is guided across the boom tensioning device 9.

The lattice boom 7 comprises a foot component 11 by means of which the lattice boom 7 is pivotably articulated to the luffing axle 6 on the upper structure 5 of the crane 1. In the drawing plane according to FIG. 1, the foot component 11 is configured in the shape of a V.

Along a lattice boom longitudinal axis 12, the foot component 11 is adjoined by a number of lattice elements 13. The lattice elements 13 are detachably interconnected along the lattice boom longitudinal axis 12. Each of the lattice elements 13 has a lattice element longitudinal axis 14 which is oriented parallel to the lattice boom longitudinal axis 12. In the illustration according to FIG. 1, the respective lattice element longitudinal axes 14 coincide with the lattice boom longitudinal axis 12. An end of the lattice boom 7 opposite the foot component 11 is provided with a head component 15. The head component 15 is used for wire guidance, in particular for a hook block 16 arranged on the head component 15. The hook block 16 is used for load lifting and holding.

Each of the lattice elements 13 has a lattice element height H which is substantially identical for all lattice elements 13. The lattice element height H may vary along the lattice boom longitudinal axis 12 for individual lattice elements 13. The lattice element height H for instance amounts to no more than 3.2 m. The lattice element height is oriented perpendicular to the lattice element longitudinal axis 14. The lattice element height H is in particular oriented parallel to the drawing plane of FIG. 1.

Each of the lattice elements 13 is in the shape of a cuboid and has a lattice element length L oriented along the lattice element longitudinal axis 14. In the work arrangement, the lattice element length L amounts to less than 4 m and in particular to no more than 3.5 m. The lattice element length is in particular identical for all lattice elements 13. The lattice element length L may vary for different lattice elements 13.

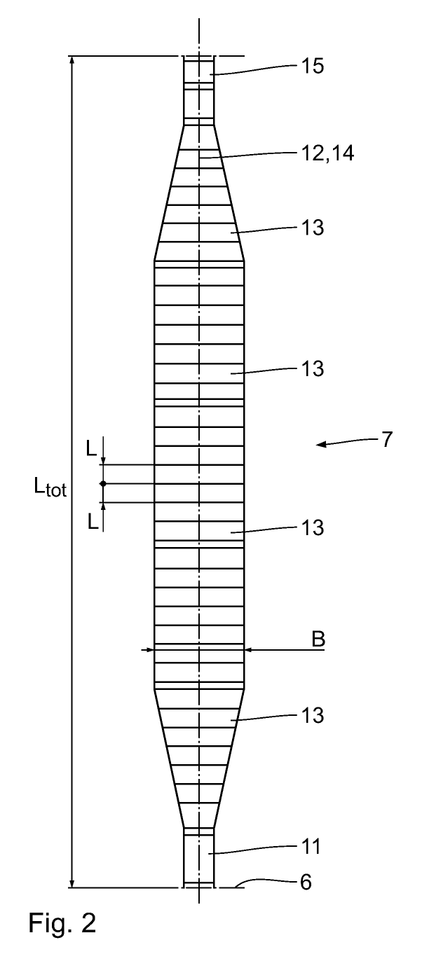

FIG. 2 is a schematic view of the lattice boom 7 according to FIG. 1. For better clarity, other components of the crane 1, in particular the crane undercarriage 2, the crane upper structure 5, the boom tensioning device 9 and the hook block 16, are not shown.

The illustration of the lattice boom 7 therefore substantially corresponds to the illustration in FIG. 1, wherein the drawing plane is rotated through 90° relative to the lattice boom longitudinal axis 12. According to the illustration in FIG. 2, it becomes evident that the lattice elements 13 have a lattice element width B which is increased relative to the lattice element length L and in particular relative to the lattice element height H. According to the illustrated exemplary embodiment, the lattice element width B amounts to 8 m in the work arrangement according to FIG. 2. In the work arrangement of the lattice element 13, the lattice boom according to the invention in particular allows a lattice element width B of more than 4 m, in particular of more than 6 m, to be maintained. Lattice element widths B of this type usually require an increased amount of effort. An increased amount of effort means for example that the lattice elements are configured in a dividable, foldable and/or collapsible manner in order to reduce the lattice elements width B required in the work arrangement for a transport of the lattice element 13. Otherwise a transport of a lattice element according to the invention of this type would not be possible using prior art means. Since the lattice elements 13 according to the invention have a reduced lattice element length L which is in particular smaller than 4 m and in particular amounts to no more than 3.5 m, a permissible transport volume for the lattice element 13 is not exceeded. This means that a lattice element 13 of this type can be transported directly in the work arrangement, in other words without requiring an additional step of dismounting, folding and/or collapsing. In particular, a transport on the road, on rails and in transport containers provided for this purpose is conceivable. Consequently it was found that the conditions determined by a maximum permissible transport volume can be taken advantage of by the fact that an increased lattice element width is possible if a lattice element length L is reduced. Reducing the lattice element length L is uncomplicated since a desired total length Lₜₒₜ of the lattice boom 7 is adjustable as required by arranging a number of lattice elements 13 one behind the other along the lattice boom longitudinal axis 12. It is therefore possible to design the lattice boom 7 in such a way as to have a desired total length Lₜₒₜ and a cross-sectional surface which is oriented perpendicular to the lattice boom longitudinal axis 12 and allows a required load bearing capacity to be achieved. The cross-sectional surface oriented perpendicular to the lattice boom longitudinal axis 12 is defined by the lattice element width B and the lattice element height H.

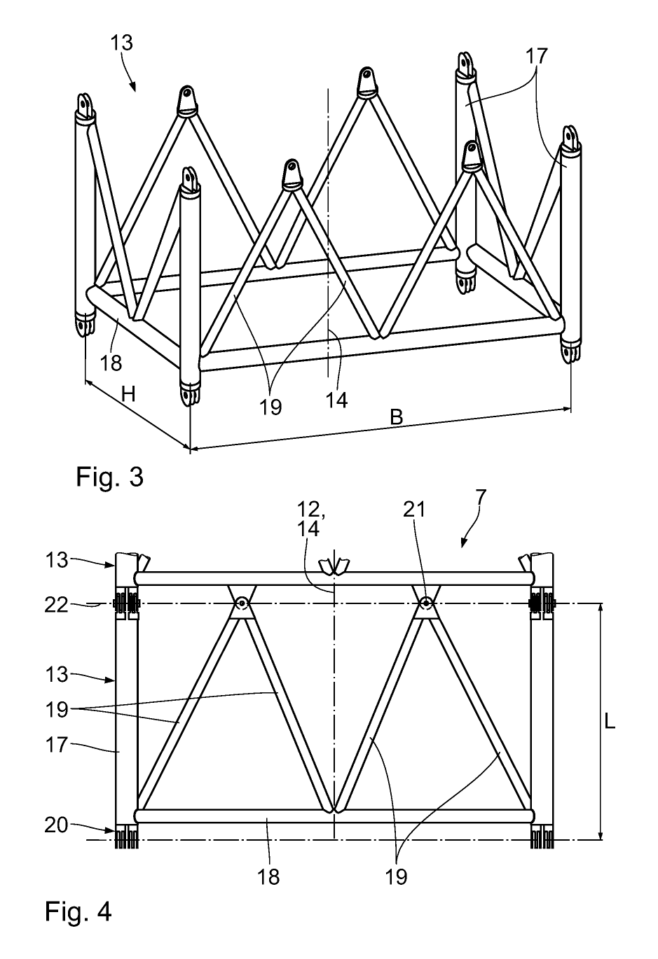

The following is a more detailed description of the lattice element 13 according to one embodiment as shown in FIG. 3 and FIG. 4. The lattice element 13 has a one-piece lattice element frame. The lattice element frame comprises four chord tubes 17 which are in each case oriented parallel to the lattice element longitudinal axis 14. Each of the chord tubes 17 is in particular hollow. The four chord tubes 17 span the cuboid shape of the lattice element 13. At a respective lower end, two adjacent chord tubes 17 are in each case rigidly interconnected by cross tubes 18 which are in each case oriented perpendicular to the lattice element longitudinal axis 14. The tubes 17, 18 are in particular welded to each other. At a respective upper end of the chord tubes 17, no cross tubes 18 are provided. The lattice element frame of the lattice element 13 is upwardly open.

A reinforcement of the lattice element frame is provided by a number of reinforcing elements 19 in the form of reinforcing tubes which are in each case arranged diagonally between in each case two adjacent chord tubes 17. The reinforcing tubes 19 are in each case rigidly interconnected, in particular by welding. Furthermore, the reinforcing tubes 19 are fastened, in particular welded, to the cross tubes 18 and/or the chord tubes 17. The lattice element frame thus formed is inseparable and rigid. The lattice element frame has a high stability. Each of the front ends of the chord tubes 17 is provided with connection devices. In other words, an upper and a lower end of each of the connection devices are oriented along the lattice element longitudinal axis 14 of the lattice element 13. The connection devices 20 are configured as multi-lugged connection lugs. According to the exemplary embodiment shown in FIG. 4, a lower connection device 20 is configured as a three-lugged connection lug. Correspondingly, a connection device 20 of the lattice element 13 shown at the top of FIG. 4 is configured as a two-lugged connection lug. This allows two adjacent lattice elements 13 to be interconnected particularly easily since a lower three-lugged connection device of one lattice element corresponds to an upper two-lugged connection device of a lower lattice element 13. The lattice elements 13 are interconnected by introducing a connection element, in particular a plug-in bolt 21, into openings of the connection lugs 20 that are flush with each other. As shown in FIG. 4, respective upper ends of the reinforcing tubes 19 and a lower side of the cross tubes 18 remote therefrom may also be provided with connection devices in the form of multi-lugged connection devices. The connection elements 21 for the connection of two adjacent lattice elements 13 are arranged in a common connection plane 22. The connection plane 22 is oriented perpendicular to the respective lattice element longitudinal axis 14 of the lattice elements 13 to be interconnected. The connection plane 22 is oriented perpendicular to the lattice boom longitudinal axis 12.

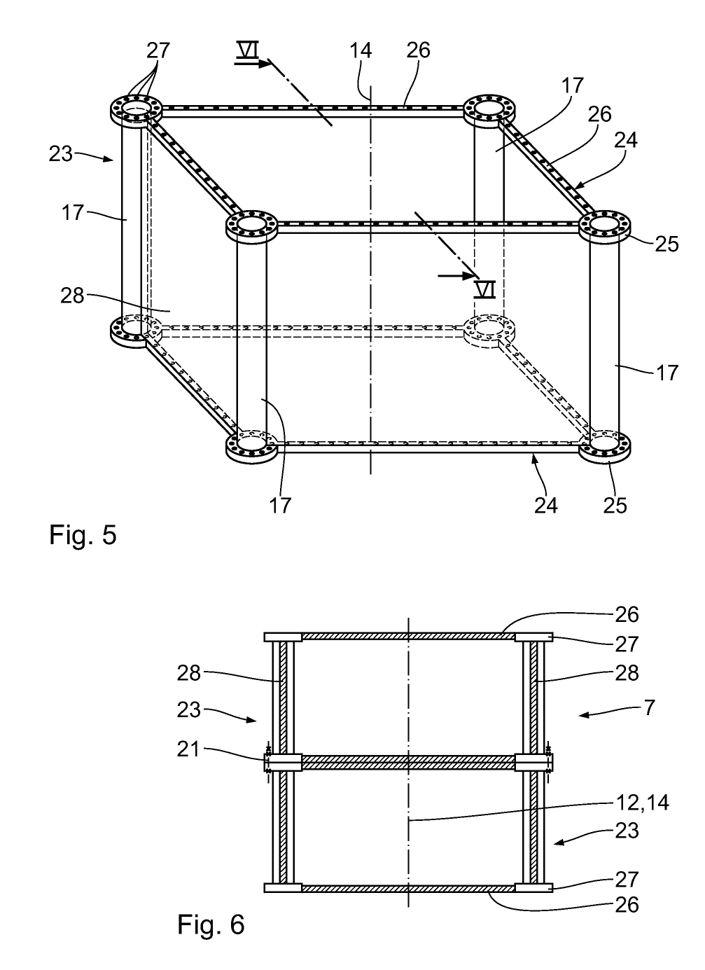

The following is a more detailed description of another embodiment of the invention as shown in FIG. 5 and FIG. 6. The lattice element 23 comprises four chord tubes 17 which are oriented parallel to the lattice element longitudinal axis 14. The chord tubes 17 are rigidly interconnected by a flange 24 provided at each of the front ends on the upper and lower sides of the chord tubes 17. In particular, the front ends of the chord tubes 17 are in each case rigidly welded to the flanges 24. This results in a one-piece, in particular inseparable and rigid, lattice element frame for the lattice element 23.

The two flanges 24 are substantially identical. The flange 24 comprises four substantially annular chord tube flanges 25 and cross flanges 26 interconnecting in each case two adjacent chord tube flanges 25. The flange 24 comprises flat strips which are arranged in a plane perpendicular to the lattice element longitudinal axis 14. The strips are provided with through-holes 27 oriented along the lattice element longitudinal axis 14. Arranged in laterally protruding sections of the flange 24, the through-holes 27 allow connection elements 21 to be inserted for interconnecting two adjacent lattice elements 23. In order to improve a filling of the lattice element 23, plate-shaped reinforcing elements 28 may be provided between two adjacent chord tubes 17 as indicated in FIG. 5 and FIG. 6. Reinforcing plates 28 of this type are in particular made of steel. It is conceivable for one or more side surfaces of the lattice element 23 to be provided with one or several reinforcing tubes instead of or in addition to a stele plate 28. The reinforcing plates 28 are in particular detachably connected to the lattice element frame of the lattice element 23. The steel plates 28 are in particular screwed to the lattice element frame. It is conceivable as well for the steel plates 28 to be inserted into grooves the chord tubes 17 are provided with for this purpose. The steel plates 28 may also be welded and/or riveted to the chord tubes 17. It is conceivable for the cross flanges 26 to be configured in one piece with the steel plates 28.

Instead of a connection element 21 in the form of a screw, plug-in bolts are conceivable as well. The connection elements 21 are in each case oriented parallel to the respective lattice element longitudinal axis 14 of the lattice elements 23, in other words parallel to the lattice boom longitudinal axis 12.

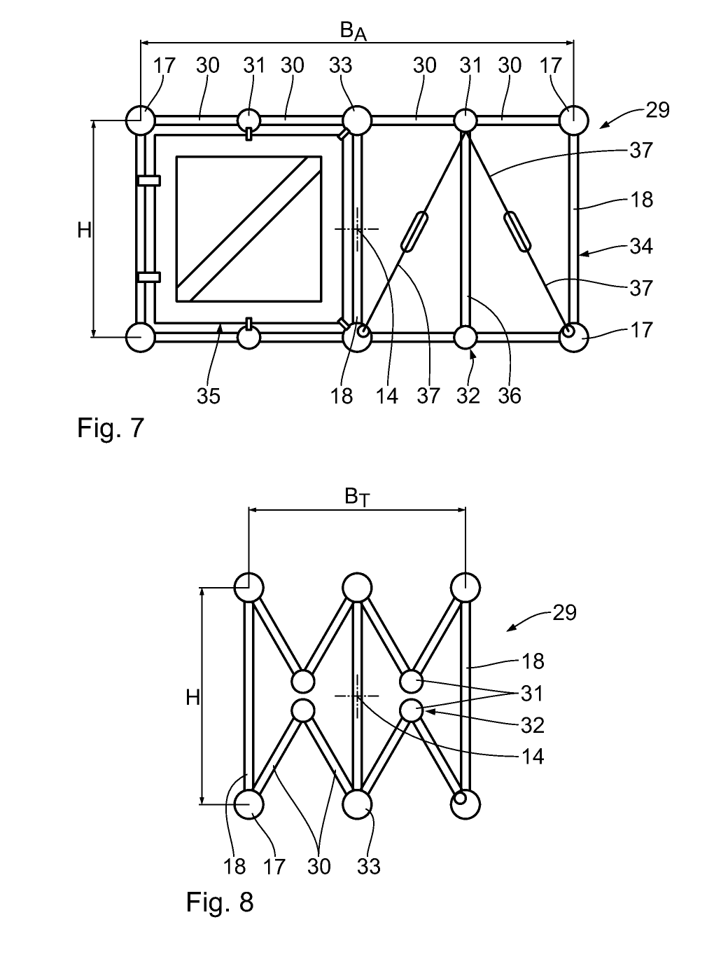

The following is a more detailed description of another embodiment of the invention as shown in FIG. 7 and FIG. 8. The lattice element 29 is in each case shown in a plane oriented perpendicular to the lattice boom longitudinal axis 12. The lattice element 29 differs from the preceding embodiments substantially in that the lattice element 29 is composed of more than one component. The lattice element 29 is foldable. In a folded-out work arrangement, the lattice element 29 has a lattice element width B_{A} which for instance amounts to 8 m. The lattice element 29 can be folded to produce a folded-in transport arrangement shown in FIG. 8. In the transport arrangement, the lattice element 29 has a lattice element width B_{T} which is smaller than the lattice element width B_{A} in the folded-out work arrangement according to FIG. 7. The lattice element width B_{T} in the folded-in transport arrangement is in particular smaller than 4 m and amounts in particular to no more than 3 m.

Folding is made possible by a number of components 30 which are in each case articulated to each other and provided in a direction along the lattice element width B. The pivoting movement takes place about a pivot axis 31 which interconnects two adjacent components 30 in such a way as to be pivotable. The pivoting axis 31 is in each case oriented parallel to the lattice element longitudinal axis 14. It is in particular conceivable for two components 30 to be interconnected in such a way as to form a hinge, in particular in the form of a piano hinge. If the components 30 are arranged along the lattice element width B, the pivot angle of a piano hinge of this type is in particular limited to a maximum of 180° as shown in FIG. 7.

The lattice element 29 shown in FIG. 7 and FIG. 8 comprises two hinges 32 of this type which are in each case arranged along the lattice element width B. The hinges 32 are in each case arranged between a chord tube 17 and a central tube 33 arranged between the chord tubes 17 and are therefore interconnected in such a way as to be pivotable. Adjacent chord tubes 17 and central tubes 33 are in each case connected in pairs by means of a reinforcing frame 34 which may for instance have two cross tubes 18 which interconnects the respective tubes 17 or 33, respectively.

In order to prevent the lattice element 29 from being accidentally folded when in the work arrangement, at least sections of the lattice element are reinforced in the work arrangement. The lattice element 29, which is symmetric relative to the cross tube 18 interconnecting the central tubes 33, is provided with a reinforcing frame 35 for securing a section of the lattice element 29 shown on the left of FIG. 7. In the plane perpendicular to the lattice element longitudinal axis 14, the reinforcing frame 35 has a rectangular shape comprising a diagonal rod interconnecting two opposite corners of the rectangle. The reinforcing frame 35 is detachably fastened to the chord tubes 17, the cross tubes 18, the central tubes 33 and/or the hinges 32. The geometry of the reinforcing frame 35, in particular the outer contour thereof, is configured in such a way that a folding of the lattice element 29 is disabled.

In the section of the lattice element 29 shown on the right of FIG. 7, a folding is prevented by a distance rod 36 which is arranged between two opposite hinges 32. The distance rod 36 may for instance be fitted to each of the two hinges 32. The distance rod 36 prevents the hinges 32 from moving toward each other. A pivoting movement of the hinges 32 is therefore impossible, thus preventing a folding of the lattice element 29. It is conceivable to use another distance element instead of the distance rod 36 in order to disable the pivoting movement of the hinges 32. It is for instance conceivable to use a distance plate which has a length along the lattice element longitudinal axis 14 that is increased relative to that of the distance rod 36. In order to achieve a sufficient cross stability, in other words in a direction parallel to the lattice element width B, diagonal wirings 37 are provided. A wiring 37 of this type for instance connects a chord tube 17 with a diagonally opposite tube of the hinge 32. The tube of the hinge 32 is in turn wired to a diagonally opposite central tube 33.

The following is a more detailed description of a folding procedure for the lattice element 29 starting from the work arrangement shown in FIG. 7. In a first step, the reinforcing frame 35, the distance rod 36 and the wirings 37 are removed from the lattice element 29. The hinges 32 are now released. The maximum pivot angle of 180° prevents the hinges 32 comprising the components 30 from pivoting in an outward direction, in other words it prevents two opposite hinges 32 from pivoting away from each other. The hinges 32 can in particular be actuated to pivot towards each other in such a way that the components 30 move towards each other. The pivot axes 31 of opposite hinges 32 are moved close to each other. The components 30 are arranged on the hinge 32 in such a way as to form a V. In this arrangement, the lattice element 29 can be transported as shown in FIG. 8. The lattice element width B_{T}, which is reduced in the transport arrangement, is smaller than the lattice element width B_{A} which has its maximum width in the work arrangement. If necessary, additional fastening means not shown in this disclosure can be used to prevent the lattice element 29, in particular the hinges 32, from folding out during the transport of the lattice element 29.

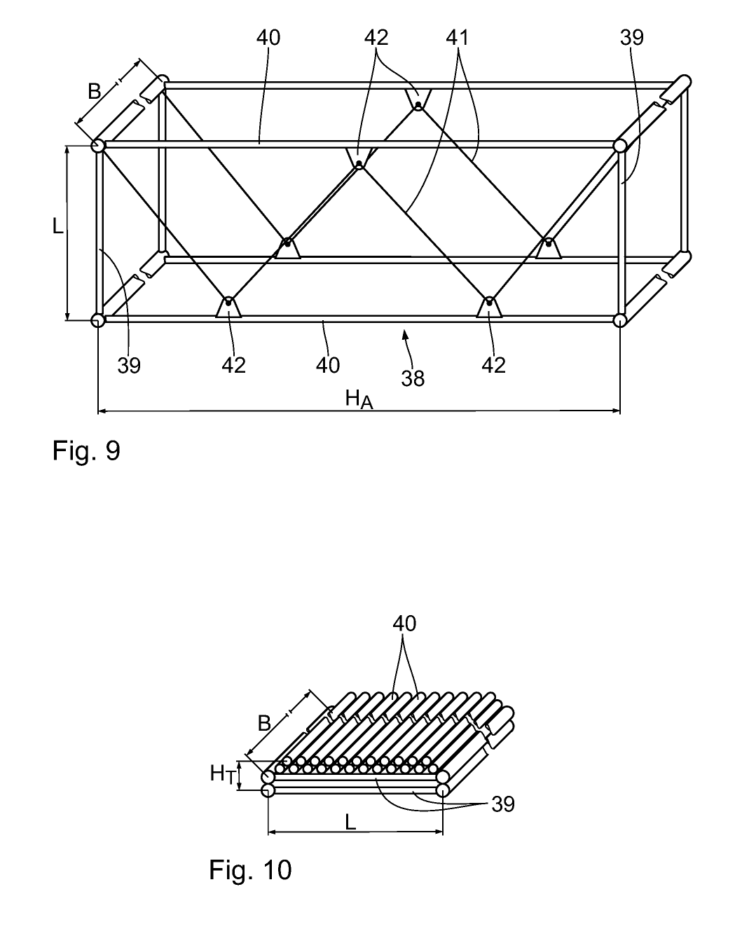

The following is a description of another embodiment of the invention by means of FIGS. 9 and 10. Just like the lattice element 29, the lattice element 38 is composed of several components. The lattice element 38 has two side components 39 which are arranged at a distance from each other. The side components 39 are arranged in a plane spanned by the lattice element width B and the lattice element length L. Each of the side components 30 is in the shape of a frame and in particular configured in one piece. The frame-like side components 39 are interconnected and thus reinforced by two filling rods 40. Each of the filling rods 40 is configured as a rod element. In addition to that, a tie fastener 41 in the form of a fiber glass tie fastener is provided. The filling rods 40 are provided with fastening lugs 42 which are welded thereto, thus allowing the tie fastener 41 to be fastened thereto so as to enable the filling rods 40 to be tied to the side components 39 in a suitable manner. It is conceivable as well that an overall tie fastener 41 is provided which is passed through the respective fastening lugs. In this case, the tie fastener 41 is configured in one piece.

The tie fastener 41 can be untied for a transport of the lattice element 38. In addition to that, the filling rods 40 between the side components can be removed. In this case, the two side components 39 may be arranged on top of each other to save space as indicated in FIG. 10; the filling rods 40 may be arranged on the frame-like side components 39. In a transport arrangement of this type, the lattice element height H_{T} is considerably reduced compared to the lattice element height H_{A} in the work arrangement according to FIG. 9. The lattice element height in the transport arrangement in particular amounts to less than 1 m. In contrast to that, the lattice element width B and the lattice element length L remain unchanged between the work arrangement and the transport arrangement.

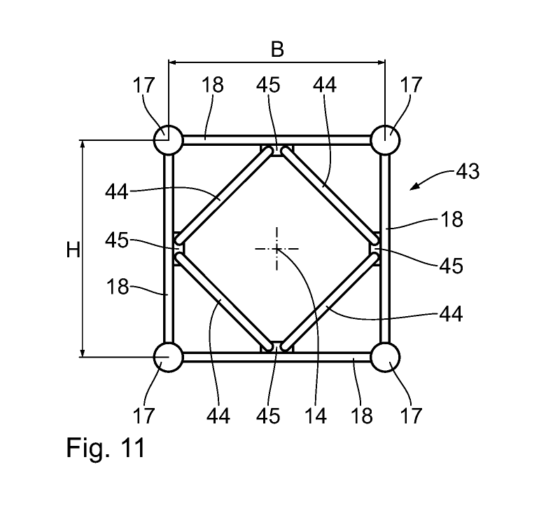

The following is a description of another embodiment of the invention as shown in FIG. 11. The lattice element 43 is configured in one piece. The lattice element 43 has four chord tubes 17 and cross tubes 18 interconnecting the chord tubes 17. In particular, two cross tubes 18 are in each case arranged between two adjacent chord tubes 17 in such a way as to be spaced from each other along the lattice element longitudinal axis 14. In the illustrated embodiment, the lattice element 43 has a lattice element width B and a lattice element height H which are substantially identical. The lattice element 43 has a cross-sectional surface oriented perpendicular to the lattice element longitudinal axis 14 which is substantially in the shape of a square. The cross-sectional surface may also be rectangular.

The lattice element 43 is provided with reinforcing elements 44. In the illustrated embodiment, the reinforcing elements 44 are configured as reinforcing tubes. The reinforcing tubes are in each case connected to fastening elements 45 arranged in the centers of the cross tubes 18. The reinforcing tubes are in particular connected to the fastening elements 45 by means of bolts. Bolts provided for this purpose are oriented parallel to the lattice element longitudinal axis 14. The reinforcing elements 44 are arranged in a frame formed by the chord tubes 17 and the cross tubes 18. The reinforcing elements 44 are oriented relative to the lattice element longitudinal axis 14 in the shape of a rhombus. The lattice element 43 has an increased stiffness.

What is claimed is:

1. A lattice boom for a crane comprising a number of lattice elements arranged one behind the other in such a way that their respective lattice element longitudinal axes are oriented along a lattice boom longitudinal axis, wherein
a. each lattice element has a lattice element width which is oriented perpendicular to the lattice element longitudinal axis and is greater than 4 m when in a work arrangement; and
b. in the work arrangement, each lattice element falls below permissible maximum dimensions for a transport of the lattice element.

2. A lattice boom according to claim 1, wherein each lattice element has a lattice element length oriented parallel to the lattice element longitudinal axis which, in the work arrangement, is smaller than 4 m.

3. A lattice boom according to claim 1, wherein the lattice element is in the shape of a cuboid.

4. A lattice boom according to claim 3, wherein the lattice element is hollow along the lattice element longitudinal axis.

5. A lattice boom according to claim 1, wherein the lattice element has a one-piece lattice element frame.

6. A lattice boom according to claim 5, wherein the one-piece lattice element frame is inseparable and rigid.

7. A lattice boom according to claim 5, wherein an upper and lower end of the lattice element, which are in each case oriented along the lattice element longitudinal axis, is in each case provided with at least one connection device to allow for a connection with a lattice element adjacent thereto along the lattice element longitudinal axis.

8. A lattice boom according to claim 5, wherein at least one reinforcing element is provided in a plane oriented parallel to the lattice element longitudinal axis for additional reinforcement of the lattice element.

9. A lattice boom according to claim 8, wherein the at least one reinforcing element is rigid.

10. A lattice boom according to claim 1, wherein the lattice element is composed of more than one component.

11. A lattice boom according to claim 10, wherein the lattice element is foldable to such an extent that the lattice element width in a folded-in transport arrangement is smaller than the lattice element width in the folded-out work arrangement of the lattice element.

12. A lattice boom according to claim 10, wherein the lattice element has a number of components which are oriented along the lattice element width and are articulated to each other.

13. A lattice boom according to claim 10, wherein the lattice element has a number of components which are interconnected in the work arrangement and detached from each other in the transport arrangement such that the lattice element height in the detached transport arrangement is smaller than the lattice element height in the interconnected work arrangement.

14. A lattice boom according to claim 13, wherein the lattice element has two frame-like side components which are in each case arranged at a distance from each other in a plane spanned by the lattice element width and the lattice element longitudinal axis.

15. A lattice boom according to claim 14, wherein the side components are interconnected in a reinforcing manner by at least one of the group comprising at least one rod element and a tie fastener.

16. A lattice boom according to claim 1, wherein the lattice elements are detachably interconnected along the lattice boom longitudinal axis.

17. A lattice boom according to claim 16, wherein the lattice elements are detachably interconnected by means of connection elements oriented along the lattice boom longitudinal axis.

18. A lattice boom according to claim 16, wherein the lattice elements are detachably interconnected by means of connection elements oriented perpendicular to the lattice boom longitudinal axis.

19. A lattice boom according to claim 1, wherein the lattice elements have a number of chord tubes which define corner points of a cross-sectional surface oriented perpendicular to the lattice element longitudinal axis, wherein the chord tubes are substantially oriented along the lattice element longitudinal axis.

20. A lattice boom according to claim 19, wherein the chord tubes are substantially oriented parallel to the lattice element longitudinal axis.

21. A lattice boom according to claim 19, wherein the lattice elements have four chord tubes of this type.

22. A lattice element for a lattice boom according to claim 1.

23. A crane comprising a lattice boom according to claim 1.
